(19) United States
(12) Patent Application Publication
(10) Pub. No.: US 2009/0232419 A1
(43) Pub. Date: Sep. 17, 2009

(54) SYSTEM FOR DETECTING MARKINGS

(75) Inventors: Mark R. SWANSON, Wisconsin Rapids, WI (US); Donald K. Zahrte, Necedah, WI (US); Peter William Jungwirth, Wisconsin Rapids, WI (US)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Renaissance Learning, Inc., Wisconsin Rapids, WI (US)

(21) Appl. No.: 12/401,988

(22) Filed: Mar. 11, 2009

Related U.S. Application Data
(60) Provisional application No. 61/036,110, filed on Mar. 13, 2008.

(51) Int. Cl. G06K 9/20

(52) U.S. Cl. 382/321

(57) ABSTRACT

A marking detection system detects markings on a printed medium, such as pencil markings in bubbles on the printed medium. The marking detection system includes a circuit board with a plurality of components thereon, including an optical subsystem and an electronic subsystem including circuitry. The marking detection system further includes a shroud for optically isolating a plurality of emitting and detecting elements of the system.

### CROSS-REFERENCE TO RELATED PATENT APPLICATIONS

This patent application claims the benefit of U.S. Provisional Patent Application No. 61/036,110, filed Mar. 13, 2008, herein incorporated by reference.

### FIELD OF THE INVENTION

The present invention relates generally to optoelectronic systems, and more particularly to an optoelectronic system for an optical mark reader that recognizes or detects marks, such as “bubbles” filled in on examination answer sheets.

### BACKGROUND OF THE INVENTION

Automated inspection and tallying of man-made markings has widespread applications. For example, in multiple-choice tests, each test taker may be instructed to indicate his or her answer to each question by darkening a delineated area, commonly called a “bubble,” among a row of bubbles on a printed medium known as an answer sheet or card. A bubble sheet or card typically bears multiple rows of bubbles for multiple questions, with the bubbles also forming columns. After a test is completed, the answer sheets or cards are then fed through an optical mark reader (OMR), which optoelectronically detects the location of the darkened bubble in each row, thereby determining the answer that the test taker chose. Similar techniques can also be used for other applications and contexts including, for example, conducting polls and elections.

FIG. 1 illustrates an exploded view of one OMR, which is known in the art and described in U.S. Pat. No. 7,068,861 to Swanson et al. issued on Jun. 27, 2006. As shown in FIG. 1, the OMR 100 includes a top portion 110 that can be coupled to a base 150. When the top portion 110 and base 150 are coupled together, a slot is defined therebetween to allow insertion and passage of a scan card or sheet through the OMR 100 for detecting the markings made thereon.

The top portion includes a top cover 112 and bottom cover 120. They can be coupled together via the tabs 126 to house various internal components including a circuit board 114, a stepper motor 118 and a computer interface cable 116. The circuit board 114 has mounted thereon an optoelectric system including an array of light-emitting and light-sensing elements 130a-j. This array 130a-j is shown as being mounted to the circuit board 114, but any number of optoelectric elements can be used to suit particular applications (e.g., relative to the number of bubbles across an answer card or sheet). The circuit board 114 also has mounted thereon connectors for detachably connecting the computer interface cable 116 and stepper motor 118, respectively, to the board 114. When the top portion 110 is assembled, the motor 118 is positioned in a cradle 122 formed in the bottom cover 120 such that a driver roller 156 protrudes through a slot 158 formed on the bottom cover 120. The circuit board 114 is positioned such that the array of optoelectric elements 130a-j is directly over a window 124 in the bottom cover 120 for reading scan card or sheet passed under the window 124. A transparent window cover (e.g., made of scratch resistant material) can be mounted in or otherwise coupled with the window 124 to protect the optoelectric elements.

When the top portion 110 and base 150 are coupled together, a spring-loaded guide roller 154 is biased against the driver roller 156. When a scan card or sheet is placed between the driver roller 156 and guide roller 154 and the motor 118 is energized, the motor 118 drives the driver roller 156 and guide roller 154 to move the scan card or sheet along a guide 152 formed in the base 150. The different rows of bubbles are thus positioned to be read under the optoelectric elements 130a-j. Each of the optoelectric elements 130a-j includes a light-emitting portion and a light-detecting portion. The optoelectronic elements 130a-j may be, for example, the EE-SY169 photo sensor package available from Omron Electronics, Schaumburg, Ill. This photo sensor package includes a red light-emitting diode (LED) that illuminates an area of the card, and a phototransistor that detects light emitted from the LED and reflected off the card or sheet. If the illuminated area is unmarked, the phototransistor outputs an unmarked voltage value (i.e., a voltage value indicative of an unmarked area) to a controller. Alternatively, if the phototransistor detects a blackened or partially marked area, the output voltage from the phototransistor will indicate how much light is being reflected back depending on how dark the mark is.

Although the foregoing-described optoelectric elements have operated sufficiently well for OMRs, a new optoelectronic system would be an important improvement in the art.

### BRIEF DESCRIPTION OF THE DRAWINGS

FIG. 1 illustrates an exploded view of a conventional OMR;

FIG. 2 illustrates a perspective view of an embodiment of a system for detecting markings according to an aspect of the present invention;

FIG. 3 illustrates a partially exploded view of an example optical subsystem of the optoelectronic system of FIG. 2;

FIG. 4 illustrates a cross-sectional view of the optical subsystem along the 3-3 plane labeled in FIG. 2 in accordance with an aspect of the present invention;

FIG. 5 illustrates an example block diagram for an embodiment of an optoelectronic system of an OMR; and

FIG. 6 illustrates an example schematic showing details of an embodiment of a light-detecting circuit of an optoelectronic system of an OMR.

### DETAILED DESCRIPTION

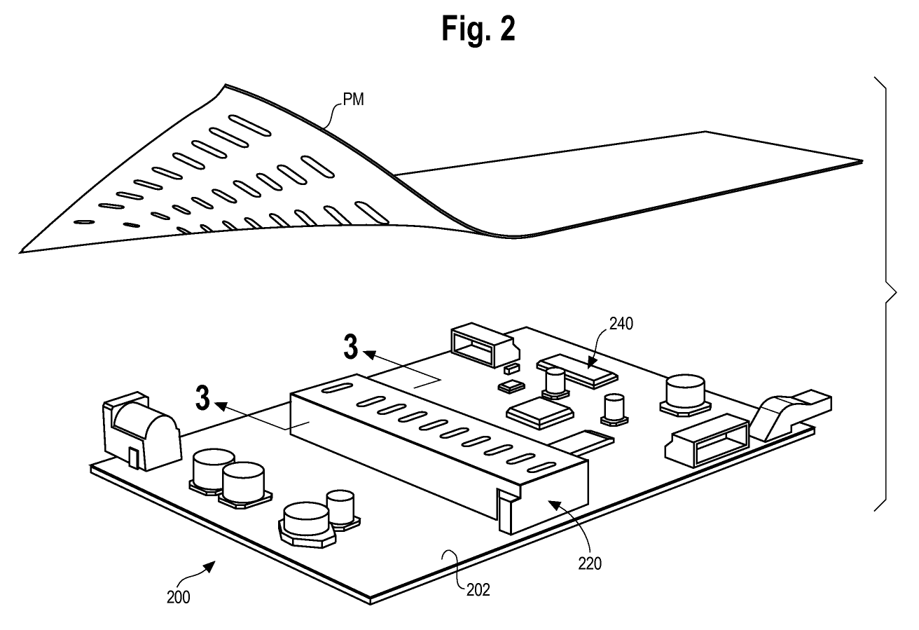

Turning now to the Figures, an example optoelectronic system for an OMR is described. As shown in FIG. 2, the optoelectronic system 200 is configured to detect markings on a printed medium PM, particularly markings in bubbles that are provided on the printed medium PM. The illustrated embodiment of the optoelectronic system 200 is shown as including a circuit board 202 with a plurality of components thereon. But the present optoelectronic system need not include the circuit board 202. Indeed, it should be appreciated that the present optoelectronic system provides improved optical and electronic subsystems that may retrofit, replace, etc., the optoelectronic elements 130a-j known in the prior art, including the control and detection circuitry thereof. The optoelectronic system 200 includes an optical subsystem 220 and an electronic subsystem 240 including circuitry, which may be embodied by, for example, wiring and electrical/electronic components on the circuit board 202, for controlling operation of and detecting marks read by the optical subsystem 220.

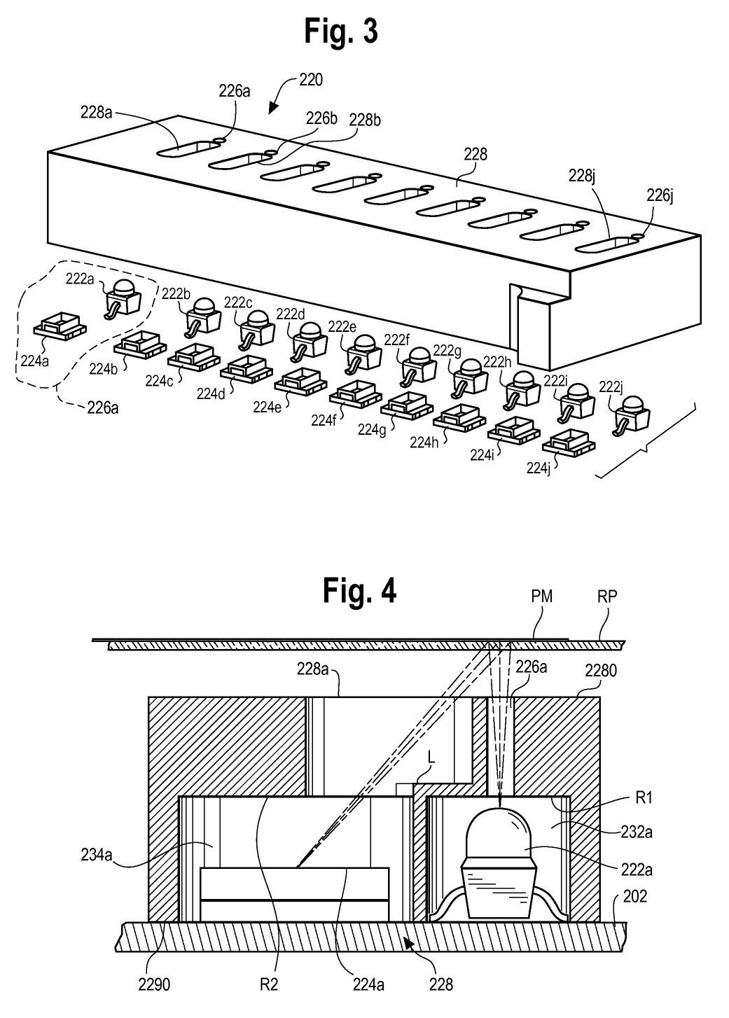

As shown in FIG. 3, the optical subsystem 220 includes a light-emitting part 222, a light-detecting part 224 and a shroud 228. The light-emitting part 222 includes ten light-emitting elements 222a-j as shown, however the light-emitting part 222 may include fewer or additional light-emitting elements. The light-emitting elements 222a-j are light emitting diodes (LEDs), for example surface-mount LEDs as shown to facilitate manufacture of the system 200. The light-detecting part 224 includes ten light-detecting elements 224a-j as shown, however the light-detecting part 224 may include fewer or additional light-detecting elements. The light-detecting elements 224a-j are optical to electrical conversion elements such as photo-sensitive diodes or transistors, for example surface-mount elements as shown to facilitate manufacture of the system 200. The light-emitting elements 222a-j and the light-detecting elements 224a-j are configured in a one to one relationship to define emitting/detecting pairs so that light emitted by one light-emitting element is reflected from the printed medium PM (FIG. 2) and received by one light-detecting element. A first emitting/detecting pair is indicated by reference number 226a and the dashed line surrounding light-emitting element 222a and light-detecting element 224a. Although only one pair 226a is indicated for clarity, further pairs may be defined by the other emitting and detecting elements 222b and 224b, 222c and 224c, etc.

The shroud 228 is configured for housing the light-emitting and light-detecting parts 222, 224 and for separating the elements 222a-j, 224a-j to help define and optically isolate the emitting/detecting pairs. As will be explained hereinafter, the shroud 228 provides a monolithic waveguide that optically couples the light-detecting element and the light-emitting element of each emitting/detecting pair (e.g., pair 226A). The shroud 228 may be made of various materials known in the art such as metal including aluminum, opaque plastic, etc. Furthermore, the shroud 228 may be formed by various methods known in the art including machining, casting, molding (e.g., injection molding), etc. Referring now to FIGS. 3 and 4, the shroud 228 is illustrated as including a generally rectangular parallelepiped-shaped body with a first surface 2280, a second surface 2290, and a plurality of apertures extending between the first and second surfaces 2280, 2290. As can be appreciated from FIG. 3, the first surface 2280 may be referred to hereinafter as the top surface or reader surface for sake of convenience of explanation because of its proximity to the printed medium PM when detecting the markings thereon. Furthermore, the second surface 2290 may be referred to hereinafter as the bottom surface or board-contacting surface for sake of convenience of explanation because of its proximity to the circuit board 202 (FIG. 4) when the optical subsystem 220 is coupled with the electrical subsystem 240 via the board 202.

As shown in FIG. 3 the plurality of apertures is defined by first apertures 226a-j and second apertures 228a-j. The first apertures 226a-j are generally round cylindrical apertures in the top surface 2280 that extend a predetermined distance from the top surface 2280 toward the bottom surface 2290. As shown in FIG. 4, each of the first apertures (first aperture 226a is shown in FIG. 4) is in communication with a first recess (232a in FIG. 4) formed in the bottom surface 2290. The first recess 232a is generally square-shaped with the first aperture 226a being at approximate centers of the first recesses 232a. The first aperture 226a extends between the recessed surfaces R1 of the first recess 232a and the top surface 2280. The recessed surface R1 may be configured approximately halfway through the thickness of the shroud 228 such that the first apertures 226a-j also extend approximately halfway through the thickness of the shroud 228. Light emitted by the light-emitting elements 222a-j, which are configured in the first recesses 232a-j, propagates through the first apertures 226a-j to illuminate bubble portions of the printed medium PM proximate the top surface 2280.

The second apertures 228a-j are generally rectangular-shaped apertures that include ledges or lands L therein when viewed from the top side 2280. The cross-section of FIG. 4 shows only the first pair of recesses 232a and 234a, but the configuration of each successive pair is substantially similar. The second aperture 228a is in communication with a second recess 234a formed in the bottom surface 2290. As shown, the second recesses 234a-j are generally rectangular-shaped with the second apertures 228a-j being laterally offset toward the first apertures 226a-j relative to the centers of the second recesses 232a-j. The second apertures 228a-j extend between the recessed surfaces R2 of the second recesses 234a-j and the top surface 2280. The recessed surfaces R2 may be configured approximately halfway through the thickness of the shroud 228 such that the second apertures 228a-j also extend approximately halfway through the thickness of the shroud 228. As shown in FIG. 4, the second apertures (one second aperture 2286 being shown in cross-section) are generally defined by laterally offset, partially overlapping recesses, namely second recess 234a, which has a recessed surface corresponding to lands or ledges L. As such, the second apertures 228a-j extend between lands or ledges L and recessed surfaces R2 of second recesses 234a-j.

As shown in FIG. 4, the light-emitting elements 222a-j are configured in the first recesses 232a-j (one first recess 232a being shown) so that light emitted by the light-emitting elements 222a-j propagates through the first apertures 226a-j (one first aperture 226a being shown) and illuminates bubbles on the printed medium, which translates along the reading plane RP. As further shown in FIG. 4, the light-detecting elements 224a-j (one element 224a being shown in FIG. 8) are configured in the second recesses 234a-j (one second recess 234a being shown) so that light reflected from the printed medium proximate to the reading plane RP propagates to the light-detecting elements 224a-j angularly through the second apertures 228a-j (one second aperture 2286 being shown), which are defined by second recesses 234a-j (one second recess 234a being shown). In view of the foregoing, it can be appreciated that the first apertures 226a-j are generally aligned with the second apertures 228a-j (and vice versa). That is, centers of the generally round cylindrical-shaped first apertures 226a-j are configured on lengthwise axes extending laterally through centers of the generally rectangular-shaped second apertures 228a-j.

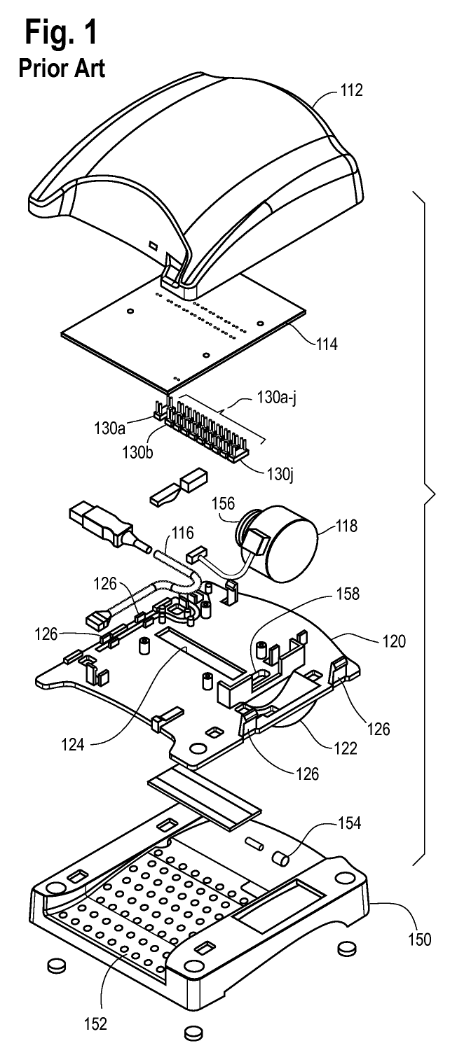

In this way the shroud 228 provides a monolithic waveguide for: 1) ensuring that light emitted from the light-emitting elements 222a-j is guided to the printed medium PM on the reading plane RP; 2) ensuring that light reflected from the printed medium PM on the reading plane RP is guided to the light-detecting elements 224a-j; and 3) optically isolating the emitting/detecting pairs from each other. Although various dimensional and angular values are shown on FIG. 4, these values are to be understood as providing one example configuration for the illustrated embodiment of the optical subsystem 220. Indeed, it should be understood that the values and configuration may be changed in various ways for various reasons including, for example, adapting the optical subsystem 220 to a motor (e.g., motor 118, FIG. 1) having a faster or slower steady-state printed medium-feeding speed, adapting the optical subsystem 220 to a user-specific or application-specific printed medium bearing custom-configured or differently-configured indicia such as, for example, differently spaced-apart bubbles, etc.

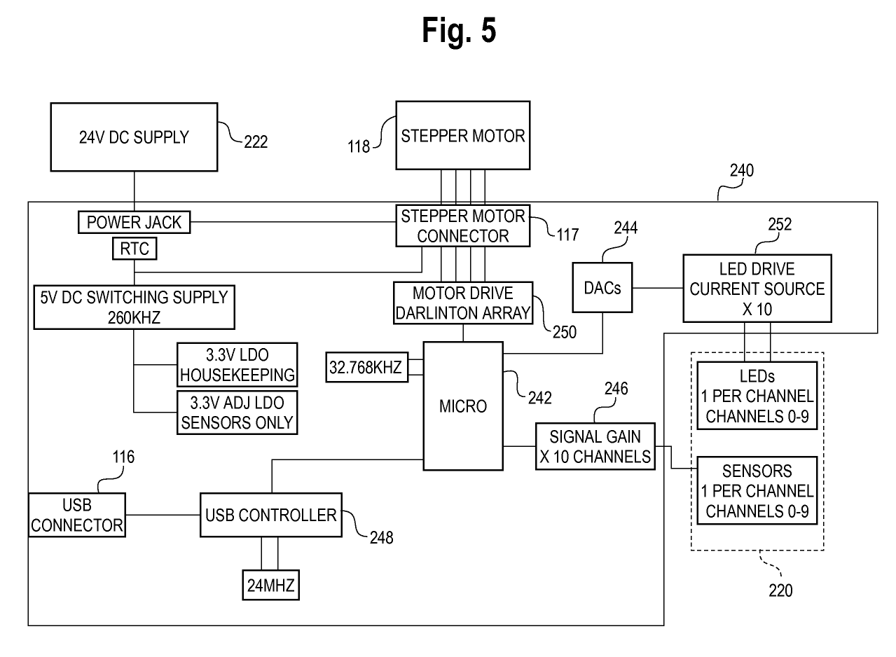

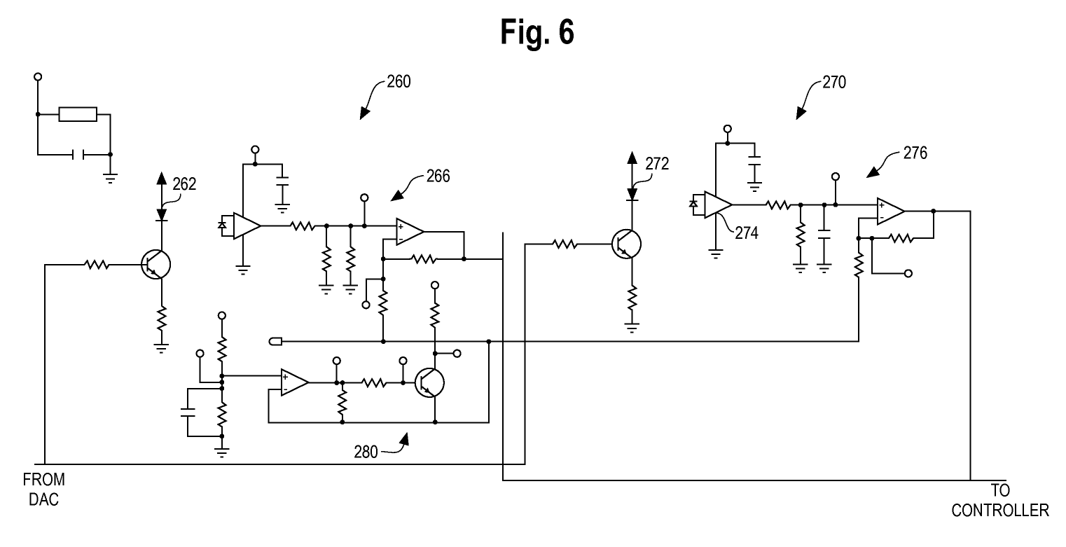

Turning now to FIGS. 5 and 6, the electronic subsystem 240, which controls operation of the optical subsystem 220 and which detects marks read by the optical subsystem 220, will be described. As shown in FIG. 5, the electronic subsystem 240 is connected with the motor 118, a power supply 222 and the optical subsystem 220. Although the electronic subsystem 240 is shown being connected to the power supply 222, alternatively the electronic subsystem 240 (and the optical subsystem 220) may be powered via the interface 116 (e.g., a USB interface that provides power and data transceiving). Furthermore, although the optical subsystem 220 is shown in FIG. 5 as being separate or distinct from the electronic subsystem 240 and connected thereto, alternatively, the subsystems 220, 240 may be combined, integral, unitary or the like (e.g., mounted to the same board 202 as shown in FIG. 2). The subsystem 240 includes a controller 242 such as a microprocessor or microcontroller as shown. The controller 242 is in communication with a digital-to-analog converter (DAC) module 244, a gain module 246, a communications module 248 and a motor drive module 250. The controller is in communication with the motor drive module 250 (e.g., motor drive darlington array as shown) to operate the motor 118 (e.g., controlling turning on, turning off, shaft speed, etc.) via the motor interface 117 (e.g., stepper motor connector as shown). The controller 242 is in communication with the communications module 248 (e.g., USB controller as shown) to transceiver data, signals, etc. with an external device such as a PC via the communications interface 116 (e.g., USB connector as shown). For example, communications module 248 may enable the controller 242 to output data to a PC relative to markings that were detected on a score sheet or card so that the data can be stored, compared with an answer key or otherwise analyzed, etc. Similarly, the communication module 248 may enable a user to test, troubleshoot, run diagnostics, calibrate, etc. the OMR and various components thereof such as the optical subsystem 220.

The DAC module 244 as shown is in communication with an LED drive module 252. The DAC module 244 and the LED drive module 252 (which in some embodiments may be combined as a DAC/LED drive module) cooperate to provide a power source and driver for the light-emitting elements 242A-J (FIG. 4) of the optical subsystem 220. The DAC and LED drive modules 244, 252 cooperate to apply variable voltages or currents to the light-emitting elements 222a-j according to a control signal output from the controller 242. The controller 242 is additionally in communication with the light-detecting elements 224a-j of the optical subsystem 220 via the gain module 246. The gain module 246 receives voltages that are output from the light-detecting elements 224a-j, processes (e.g., amplifies and/or filters) the voltages, and outputs the processed voltages to the controller 242. In some embodiments the gain module 246 may include a gain/spread circuit to achieve higher resolution for the controller's analog to digital converter (ADC).

Although not shown in FIG. 5, the controller 242 may also be in communication with a memory module such as an electrically erasable programmable read-only memory (EEPROM) module. The memory module may be used to store executable instructions (e.g., firmware) for operating various functions of the OMR such as, for example, the optical subsystem 220 or the motor 118, calibration data and other data known in the art. The memory module may also be in communication with the DAC module 244 and the communications module 248.

FIG. 6 illustrates an example schematic diagram showing an embodiment of a circuit for two channels (i.e., two emitting/detecting pairs) of the optical subsystem 220 and two channels of a gain module 246 (FIG. 4) with a gain/spread circuit. As shown in FIG. 6, a first channel 260 includes a light-emitting element 262 (an LED D11 as shown), a light-detecting element 264 (a light-to-voltage converter integrated circuit package U20 as shown), and an amplifying circuit 266. The amplifying circuit 266 includes op-amp U22-B and various passive components for voltage division, RC filtering etc. of the voltage output from light-detecting element 264. Similarly, a second channel 270 includes a light-emitting element 272 (an LED D12 as shown), a light-detecting element 274 (a light-to-voltage converter integrated circuit package U21 as shown), and an amplifying circuit 276. The amplifying circuit 276, which as shown is substantially similar to amplifying circuit 266, includes op-amp U22-D and various passive components for voltage division, RC filtering etc. of the voltage output from light-detecting element 274. Furthermore as shown in FIG. 6, a gain/spread circuit 280 couples the amplifying circuits 266, 276. Although component values and part numbers of various elements of the circuit are shown in FIG. 6, it should be appreciated that the values and part numbers are provided as examples and are not to be taken as limiting the present system and method to any specific component values, elements or interconnections thereof. Indeed, the circuit is flexible so that it may be adapted, changed, and/or configured with various different component values and elements for various reasons including, for example changing performance characteristics, etc.

In view of the foregoing it can be appreciated that the electronic subsystem 240 is configured to derive, from the signals generated by the light-detecting elements relative to light emitted by the light-emitting elements, signals indicative of the reflectance of the portions of the printed medium so that the OMR can output data regarding marking made in bubbles of the printed medium by test takers, voters and the like.

The use of the terms “a” and “an” and “the” and similar referents in the context of describing the invention are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Various example embodiments of this invention are described herein. It should be understood that the illustrated and described embodiments are exemplary only, and should not be taken as limiting the scope of the invention.

What is claimed is:

1. A marking detection system, comprising
a plurality of light-emitting elements disposed on a mechanical support;
a plurality of light-detecting elements disposed on the mechanical support; and
a shroud disposed between a reading plane and the mechanical support, the shroud comprising
a plurality of emitting recesses in which the plurality of light-emitting elements are disposed; and
a plurality of detecting recesses in which the plurality of light-detecting elements are disposed.

2. The marking detection system of claim 1, further comprising:
an electronic subsystem comprising a controller connected to a source of power and a motor.

3. The marking detection system of claim 2, wherein the electronic subsystem further comprises a communications module and a motor drive module, wherein the controller is in communication with the motor drive module to operate the motor and the controller is in communication with the communications module to receive and transmit signals from an external device.

4. The marking detection system of claim 1, further comprising a stepper motor disposed on the mechanical support adapted to move printed material along the reading plane in a direction parallel to the path of light propagation from the plurality of light-emitting elements to the plurality of light-detecting elements.

5. The marking detection system of claim 1, wherein the plurality of light-emitting elements are a plurality of light-emitting diodes.

6. The marking detection system of claim 1, wherein the plurality of light-detecting elements are a plurality of photodiodes.

7. The marking detection system of claim 1, further comprising a gain module connected to the plurality of light-detecting elements.

8. The marking detection system of claim 7, wherein the gain module further comprises a gain/spread circuit connected to the plurality of light-detecting elements.

9. The marking detection system of claim 8, wherein the gain/spread circuit couples at least two amplifying circuits connected to at least two of the plurality of light-detecting elements.

10. A shroud for a marking detection system, the shroud comprising:
at least two light-emitting apertures disposed between a first line on a mechanical support and a reading plane; and
at least two light-detecting apertures disposed between a second line on the mechanical support and the reading plane,
wherein the first line and the second line are spaced apart on the mechanical support along a direction parallel to a movement of a printed medium supplied to the marking detection system.

11. The shroud of claim 10, wherein the at least two light-emitting apertures are cylindrical in shape.

12. The shroud of claim 10, wherein the at least-two light-detecting apertures are elongated in shape.

13. The shroud of claim 10, wherein the length-wise axes of the at least two light-detecting apertures extends laterally through the centers of the at least two light-emitting apertures.

14. The shroud of claim 10, wherein the number of light-emitting apertures and the number of light-detecting apertures is equal.

15. The shroud of claim 14, wherein there are ten light-emitting apertures and ten light-detecting apertures.

16. The shroud of claim 10, wherein the number of light-emitting apertures and light-detecting apertures corresponds to a number of columns of markings on the printed medium.

17. A shroud for a marking detection system, comprising:
a means for optically isolating a plurality of light-emitting elements from a plurality of light-detecting elements.

18. The shroud of claim 17, wherein the means for optically isolating includes both light-emitting apertures and light-detecting apertures.

19. The shroud of claim 18, wherein the number of light-emitting and light-detecting apertures is equal.

20. The shroud of claim 18 wherein the number of light-emitting or light-detecting apertures corresponds to a number of columns of markings on a printed medium.
